(19) United States
(12) Patent Application Publication
(10) Pub. No.: US 2014/0149264 A1
(43) Pub. Date: May 29, 2014

(54) Method and system for virtual collaborative shopping

(71) Applicants: Hemanth Kumar Satyanarayana, Tirupati (IN); Sandeep Reddy Goli, Hyderabad (IN)

(72) Inventors: Hemanth Kumar Satyanarayana, Tirupati (IN); Sandeep Reddy Goli, Hyderabad (IN)

(21) Appl. No.: 14/126,376

(22) PCT Filed: Jun. 14, 2012
(86) PCT No.: PCT/IN2012/000418

§ 371 Date: Dec. 13, 2013

(30) Foreign Application Priority Data
Jun. 14, 2011 (IN) 2019/CHE/2011

(51) Int. Cl. G06Q 30/06

(52) U.S. Cl. CPC G06Q 30/0643
USPC 705/27.2

(57) ABSTRACT

The present invention provides an apparatus and process to share digital images and videos of a user wearing virtual apparel. The invention comprises of a camera 201 for capturing images and videos; a central processing unit (CPU) that obtains camera media feed and processes it to augment digital imagery of apparel; the CPU being configured to track a user in the media feed; a display screen 203 that displays the processed media feed; an interne adapter 204 capable of connecting to the interne; the CPU configured to upload the processed media feed online to a server 205 and further send the web location of the uploaded image or video, preferably in a text message using a cellular network 206 to the user's mobile phone 207. The user 251 can share the text message with others enabling them to view the uploaded content on an interne enabled device through a private link or through a social networking platform.

The embodiments of the present invention described herein relates to the process and apparatus used for sharing digital imagery of a user wearing virtual apparel, with other people, by utilizing computer and mobile networks. The present invention relates generally to the fields of image processing and digital transmission.

### BACKGROUND AND PRIOR ART

Apparel shopping in-store or on the internet continues to be a growing industry with time. It can be reasoned that the rising population and rising per-capita income in India and several other countries plays a major role in this industry as clothing is one of the essential needs of human beings. Infrastructure in cities and towns, however, do not continue to get at least equally better as the rising clothing shopping demands.

An average customer doesn't find driving to apparel stores and buying apparel a pleasant experience as years ago, primarily because of population congestion. With shortage of space and no scope for expansion, demand for trial rooms have increased and trial room management by the store owner has become even more difficult. As an alternative to the physical trial room, innovative solutions in augmented reality and virtual reality technologies provide the “virtual fitting room” experience.

U.S. Pat. No. 5,850,222 entitled “Method and system for displaying a graphic image of a person modeling a garment” published on 15 Dec. 1998 in the name of D. CONE, describes in particular a method and system for merging the data representing a three-dimensional human body model obtained from a standard model stored in a database and produced from the measurements of a person, with the data representing a two-dimensional garment model. The result is a simulation of the person wearing the garment on the computer screen.

U.S. Pat. No. 6,546,309 entitled “Virtual fitting room” discloses in particular a method enabling a customer to virtually try on a selected garment by retrieving a mathematical model of the customer's body, a garment model of the selected garment, and thereby determining the fit analysis of the selected garment on the customer, considering plurality of fit factors by comparing each of the fit factors of the determined size garment to the mathematical model of the customer's body. This patent covers just the aspect of determining a fit analysis of a garment versus a customer.

U.S. Pat. No. 7,039,486 entitled “Method and device for viewing, archiving and transmitting a garment model over a computer network” published on 2 May 2006 in the name of Wang, Kenneth Kuk-Kei describes a method for viewing, archiving and transmitting a garment model over a computer network. The method comprises photographing 231 a physical mannequin 233 from several different directions, the mannequin 233 being a copy of a virtual human model which is representative of the target consumer (FIG. 6). The virtual mannequin viewing layers and the garment model are generated from digital images of the naked or clothed mannequin. The merged data of the viewing layers and the garment model are archived in a base and transmitted over an intranet, an extranet or the Internet for the purpose of remote viewing. The method and device are suitable for the design, manufacture and inspection of clothing samples in the clothing industry. This patent describes a method of storing and transmitting apparel data over internet.

Prior art covers problems from the design and inspection aspects but fails to enable a collaborative shopping experience when trying on apparel and accessories in a virtual fitting room. With the increasing trend of seeking instant feedback from friends and relatives, who are often geographically distributed, a lot of shoppers work at far away locations, often across several countries and meet only occasionally.

### SUMMARY

The present invention describes an apparatus and method of sharing digital images and videos of a user wearing virtual apparel with his/her family and friends, through computer networks and/or mobile networks, therefore making the shopper's in-store experience satisfying through collaborative shopping.

The overall process is described by the stages of
1. Digital Apparel data collection and storage
2. Image or Video Capture
3. Image Processing
4. Augmentation and Display process
5. Input Data Collection and Image Storage
6. Message Transfer process
7. Collaborator's Experience

The embodiment of the invention majorly includes a digital camera, a computer, a display screen, an internet adapter, a networked server computer and mobile phones. The virtual fitting room of the present invention is designed in such a way that the shopper/customer can easily share his/her shopping experience with his/her family or friends who may be at different locations using a social networking platform, using computer networks or mobile networks. The collaborators may see the digital image of the customer/user wearing virtual digital apparel. Therefore the user gets an instantaneous feedback about the fitting, looks and other quality of the digital garment augmented on the user's body from a number of the people who are at a different location.

### BRIEF DESCRIPTION OF THE DRAWINGS

FIG. 1A illustrates schematic view 1 of the overall process of collaborative apparel shopping.

FIG. 1B illustrates schematic view 2 of the overall process.

FIG. 1C illustrates the overall system components.

FIG. 2 illustrates the steps of digital apparel data collection.

FIG. 3 illustrates the abstract step of Augmentation and display in detail.

FIG. 4 illustrates the abstract step of Message transfer process in detail.

FIG. 5 illustrates the overall components of the system of the present invention.

FIG. 6 illustrates Digital Apparel data Collection process (STAGE A1).

FIG. 7 illustrates Digital Apparel Data Storage process (STAGE A2).

FIG. 8 illustrates Image/Video Capture process (STAGE B).

FIG. 9 illustrates Image processing (Face and body measurement capture) (STAGE C).

FIG. 10 illustrates Augmentation and display process (STAGE D).

FIG. 11 illustrates three different modes of Input data collection process (STAGE E).

FIG. 12 illustrates Message Transfer process (STAGE F).

FIG. 13 illustrates Collaborator's Experience.

### DETAILED DESCRIPTION OF THE ACCOMPANYING EMBODIMENTS

A broad definition of virtual fitting room is to help customers try out digital apparel, virtually and seamlessly. Embodiments described herein achieve a new objective of enabling collaborative shopping experience for apparel customers. The present invention defines a system and method to enable custom designing within a virtual fitting room in order to share the shopping experience of a customer with his/her friends and family who may be at different locations.

Embodiments of the present invention described herein more particularly relate to the apparatus and process of sharing digital images and videos of a user wearing virtual apparel with others, through computer networks and/or mobile networks. The process involves multiple stages of operation consisting of user image/video capture, image processing and augmentation, user input data collection, imagery storage and message transfer.

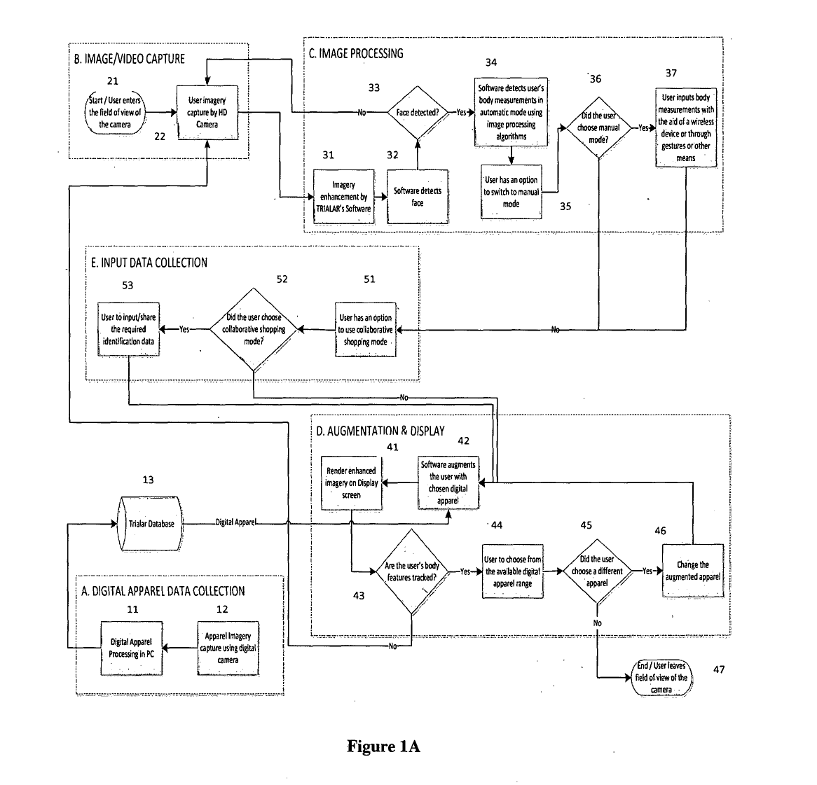

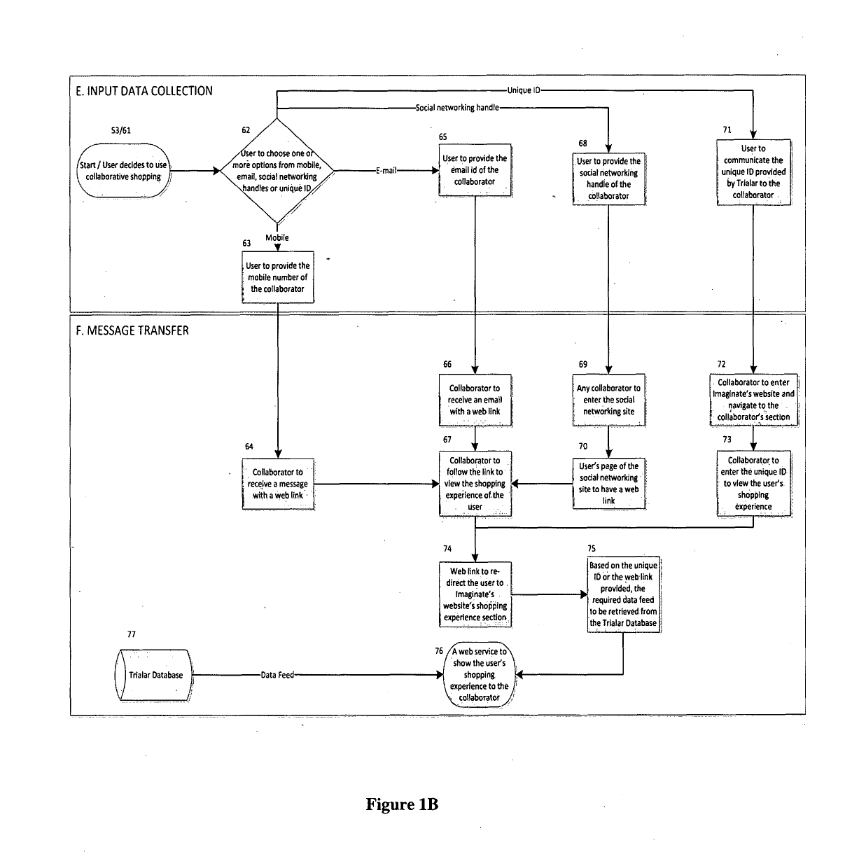

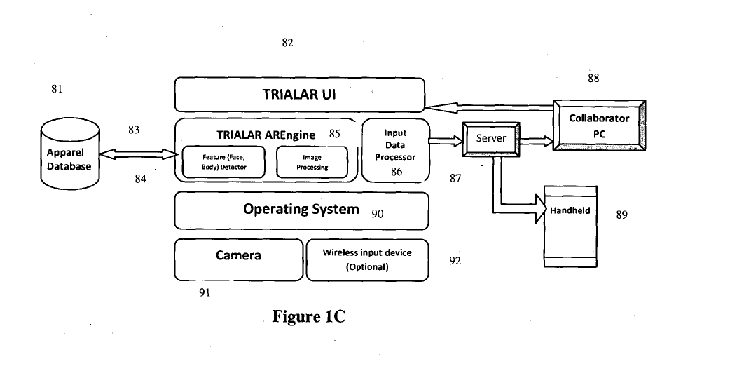

FIG. 1A, 1B and 1C illustrates the schematic view 1, 2 and system components of the overall process of collaborative apparel shopping which includes the processes of digital apparel data collection, image/video capture, image processing, augmentation and display, input data collection and message transfer process. Also, FIG. 1A, 1B and 1C describes the interactions of the user with TrialAR 77 and the mechanism of collaborative shopping.

The digital apparel data collection process as mentioned earlier involves capturing the apparel imagery using digital camera 12, processing the image 11 and storing it in a database 13. When the user is positioned in the field of view (FOV) of the camera 21, his/her image is captured using HD camera 22, in the image/video capture process. The image taken by the HD camera is enhanced by the TrialAR's software 31 which detects the face 32, 33 and body measurements of the user in automatic mode using image processing algorithms 34. The user may also manually put the body measurements with the aid of a wireless device or through gestures or other means 35, 36, 37. The enhanced image 31 is rendered on display screen 41 by augmenting the user's image with the image of the digital apparel 42, thereby tracking the user's body features 43. The user then has an option to choose from the available digital apparel range 44 from which he/she may choose 46, or leave the field of view of the camera 47. The process of the image or video capture may be repeated if the user's body features are not tracked.

FIG. 1A and 1B shows how the present invention operates when the user chooses the collaborative shopping mode 51, 52. During the input data collection process, the identification data provided by him/her is shared with others 53. Further, a message transfer process is enabled when the user decides to shop collaboratively 61 wherein he/she may choose one or more options from mobile, email, social networking handles or unique ID 62. For this the user can be asked to provide the mobile number 63, email ID 65 or social networking handle 68 of the collaborator and initiate the collaboration by sending a web link to these intended entity through a message 64, email 66 or the social networking site 69. The collaborating entity can then view the shopping experience of the user 67. The user may also choose to communicate the unique ID provided by the present invention (TrialAR) to the collaborator 71 with the help of which the collaborator can, enter a website (Imaginate's) and navigate to their section 72 and view the user's shopping experience 73. Soon after this the user is redirected to Imaginate's website's shopping experience section 74. Here, based on the user's unique ID or web link provided, the required data can be retrieved from the TrialAR Database 75. This shopping experience can be shown to the collaborator by the web service 76 and the data is stored in the TrialAR Database 77.

FIG. 1C shows the TrialAR system components including a TrialAR UI 82, a TrialAR Engine 85 having a feature detector (including face and body detection) and an image processing unit. An input data processor 86 is also present, which sends inputs to a server 87 which interacts both with the user's handheld 89 and the collaborator's device(s) including a PC 88. While this is one embodiment of the invention, both the user and the collaborator could use one of many fixed line or mobile devices, connected via any of computer, telephone or mobile networks. An Operating System 90 also exists alongside a camera 91 and an optional wireless input device 92. The TrialAR engine 85 interacts with an apparel database 81.

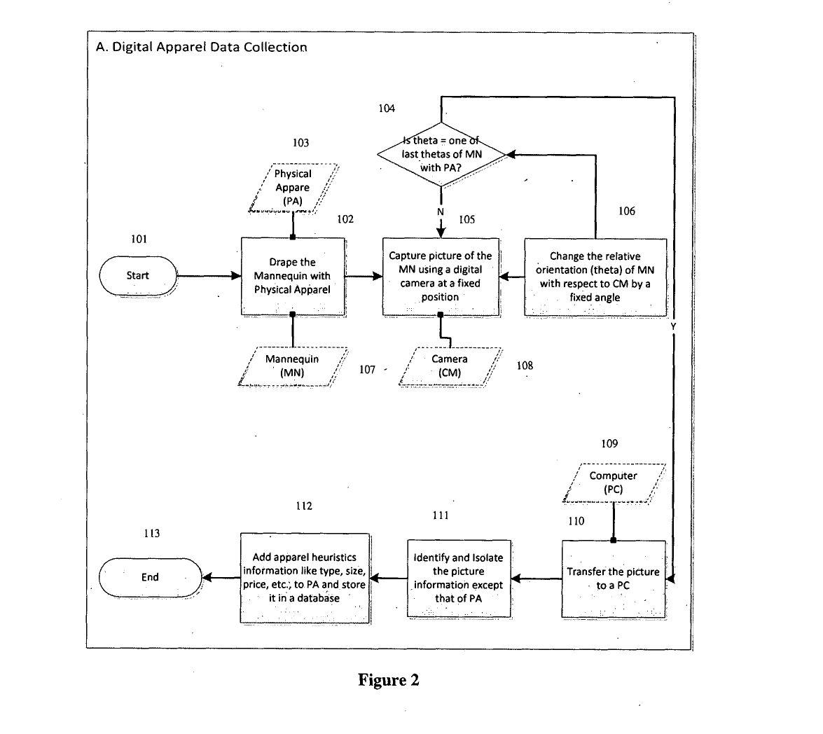

FIG. 2 illustrates the step of Digital Apparel data collection, in detail. This step starts 101 with the step of draping 102 the Mannequin 107 (MN) with the physical apparel 103 (PA). This is followed by the step of capturing 105 the picture of the MN using a digital camera 108 (CM) at a fixed position. A value “theta”is checked 104 against previous values of theta, said theta being obtained for each unique combination of (MN, PA), as the relative orientation of MN with respect to CM by a fixed angle. If theta does not exist, the step 105 is repeated. If theta already exists, the picture is transferred 110 to a computing device 109 (PC). This is followed by the step of identifying and isolating the picture information, except that of the PA 111. After this, the apparel heuristics such as type, size, price, etc. are added to the PA and stored in a database 112 after which the abstract step of Digital Apparel data collection ends 113. If there is a change in the relative orientation (theta) of MN with respect to CM by a fixed angle 106, the step of capturing 105 the picture of the MN using a digital camera 108 (CM) at a fixed position is repeated.

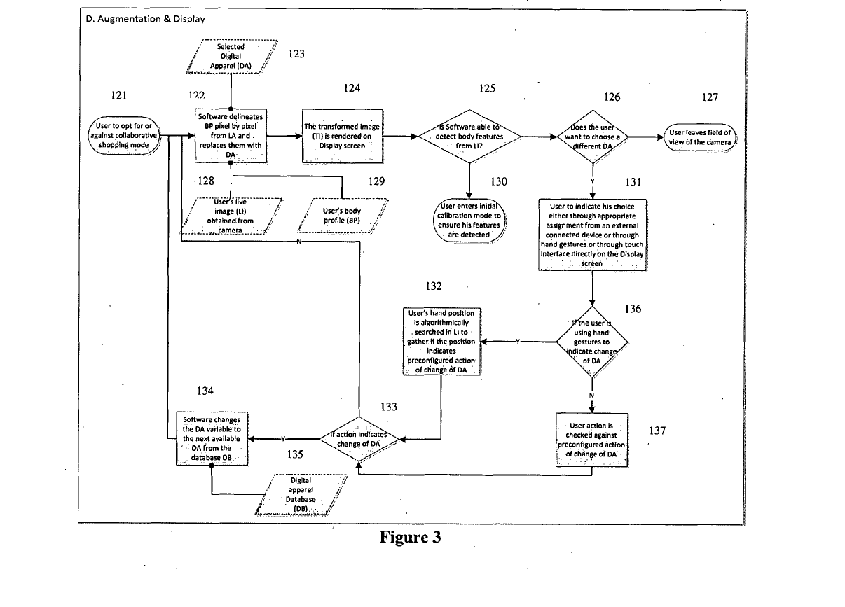

FIG. 3 illustrates the abstract step of Augmentation and display in detail. At first, the user is allowed to choose whether or not they want to enable the collaborative shopping mode 121. The present system then delineates 122 the user's body profile 129 (BP), pixel by pixel, from the user's live image 128 (LI) obtained from the camera and replaces them with the selected digital apparel 123 (DA). The transformed image (TI) is then rendered on the display screen 124. This is followed by a check to see if the system is able to detect body features from LI 125. If not, the user is asked to enter an initial calibration mode to ensure his or her features are detected 130. If the system can detect the body features, the user(s) are asked whether they want to choose a different DA 126. If not, the user leaves the field of view of the camera 127. If so, the user(s) may indicate their choice 131 either through appropriate assignment from an external connected device or through hand gestures or through touch interface directly on the display screen. Following this, the system checks to see if the user is using hand gestures to indicate change of DA 136. If not, the user action is checked against a preconfigured action for change of DA 137 and if so, the user's hand position is searched in LI 132 to gather if the position indicates preconfigured action of change of DA. The system then uses the outcome of steps 132 and 137 to check 133 if the action indicates a change of DA. If not, the system goes back to perform step 122. If so, the system changes the DA variable to the next available DA 134 from the digital apparel database 135 (DB).

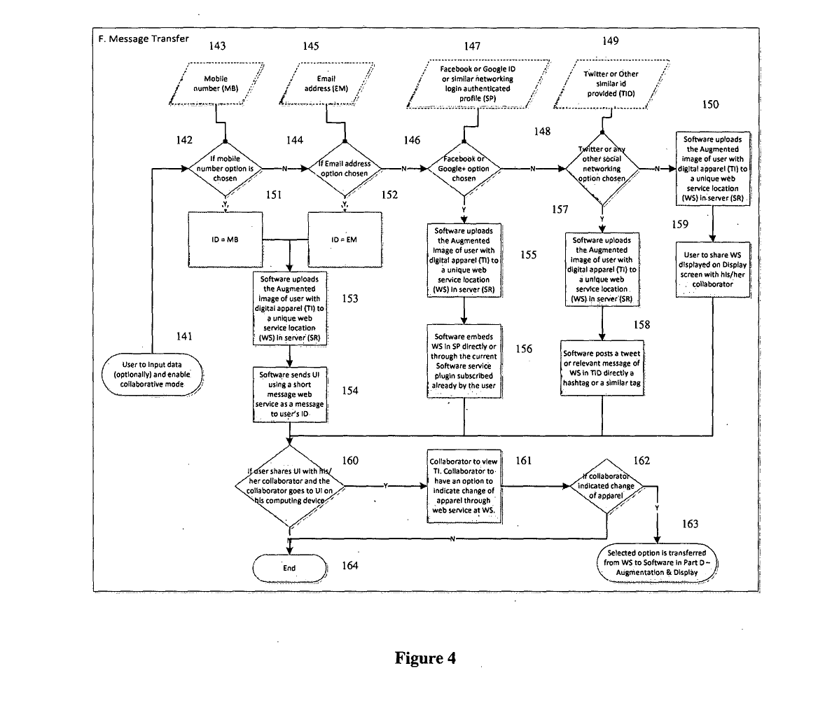

FIG. 4 illustrates the abstract step of collaboration via Message transfer, in detail. Initially, the user has a choice to input data and enable collaborative mode 141, wherein the user may choose any of a mobile number 143 (MB), an email address 145 (EM), a social networking ID, which is authenticated 147 (SP) or a twitter ID 149 (TID). If a mobile number is chosen 142, the value of “ID” is set to “MB”151. If an email address is chosen 144, the value of “ID” is set to “EM”152. The system then uploads the augmented image of the user with the digital apparel (TI) to a unique web service location (WS) in a server (SR) 153. After this, the system sends the UI using a short message web service as a message to the user's ID 154. If the user has chosen 146 a social networking ID, which is authenticated 147 (SP), the system uploads the augmented image of the user with the digital apparel (TI) to a unique web service location (WS) in a server (SR) 155, following which the system embeds WS in SP directly or through the current service plugin subscribed to by the user beforehand. If the user has chosen 148 a twitter ID 149 (TID), the system uploads the augmented image of the user with the digital apparel (TI) to a unique web service location (WS) in a server (SR) 158, following which the system posts a tweet or relevant message of WS into TID directly including a hash tag. If none of MB 143, EM 145, SP 147 or TID 149 are chosen, the system uploads the augmented image of the user with the digital apparel (TI) to a unique web service location (WS) in a server (SR) 157.

Following this, if the user shares the UI with their collaborators, the collaborator goes to the UI on his computing device 160, the collaborator gets to view TI 161 wherein the collaborator has an option to indicate change of apparel through a web service at WS. If the collaborator indicates a change of apparel 162, the selected option is transferred from WS to software in the abstract step of augmentation and display 163. If the collaborator does not go to the UI on their computing device in step 160 or the collaborator indicates no change of apparel in step 162, the message transfer ends 164.

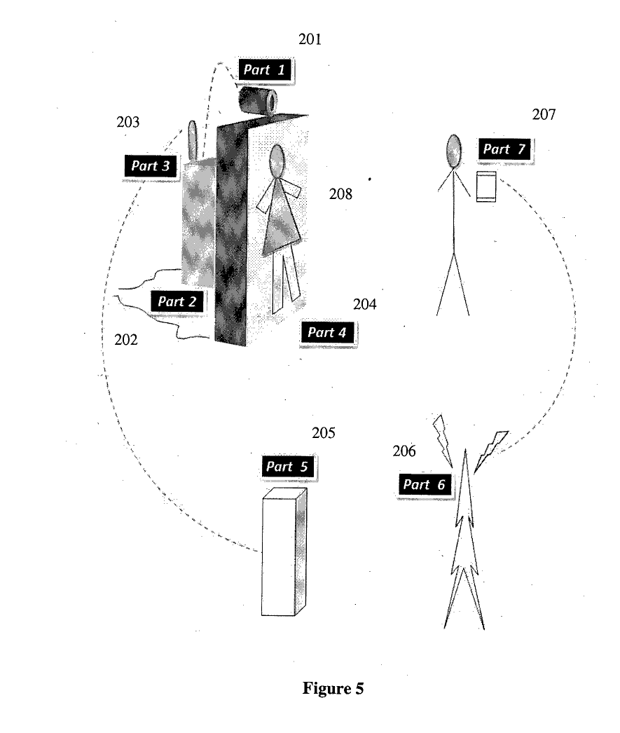

FIG. 5 illustrates the overall components of the system of the present invention. Embodiments of the apparatus of the invention (also referred to as TrialAR 253) consists of at least a digital camera (part 1) 201, a computer (part 2) 202, a display screen (part 3) 203, an interne adapter (part 4) 204, a networked server computer (part 5) 205 and a mobile phone (part 6) 206.

The user of the invention is an apparel customer who intends to use the invention to simultaneously try out digital apparel and share the resulting imagery 208 with others.

The following is a description of the various stages involved in the process of invention:

Stage A1 and A2: Digital Apparel Data Collection and Storage

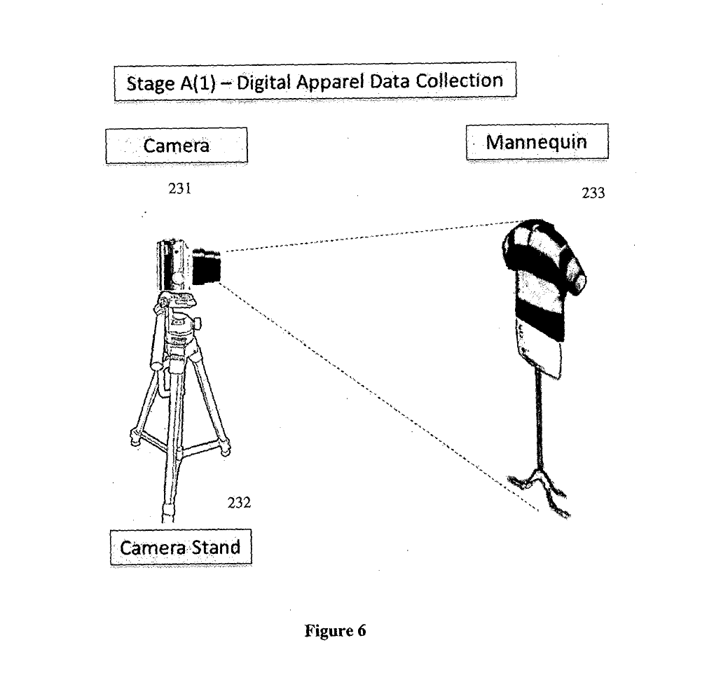

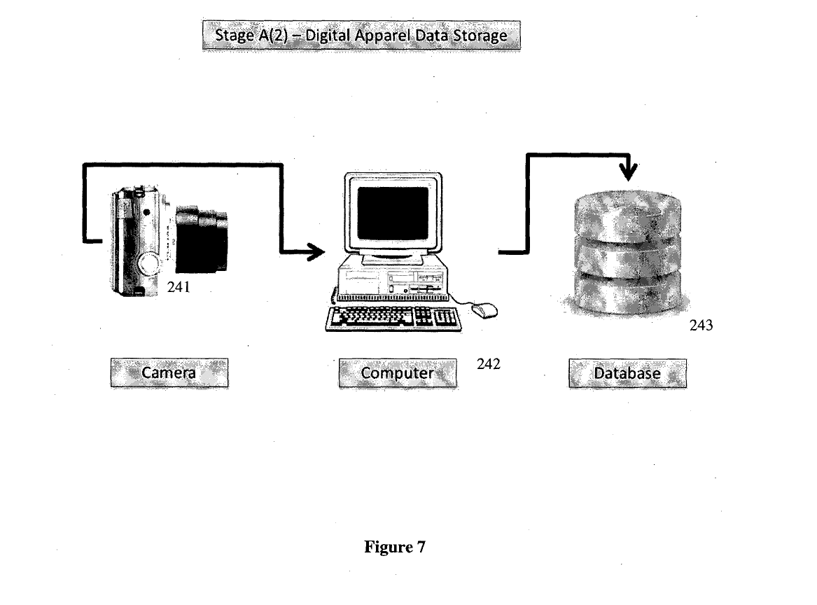

FIG. 6 and FIG. 7 illustrates digital apparel data collection and storage process wherein the physical apparel, the imagery of which 208 is intended to be shared with others through the current invention, are photographed using a digital camera 241 in good ambient lighting conditions. The digital imagery 208 thus captured are then stored in a digital database 243 that can be accessed by a Computer 242, which constitutes an embodiment of the apparatus of the invention.

Stage B: Image/Video Capture

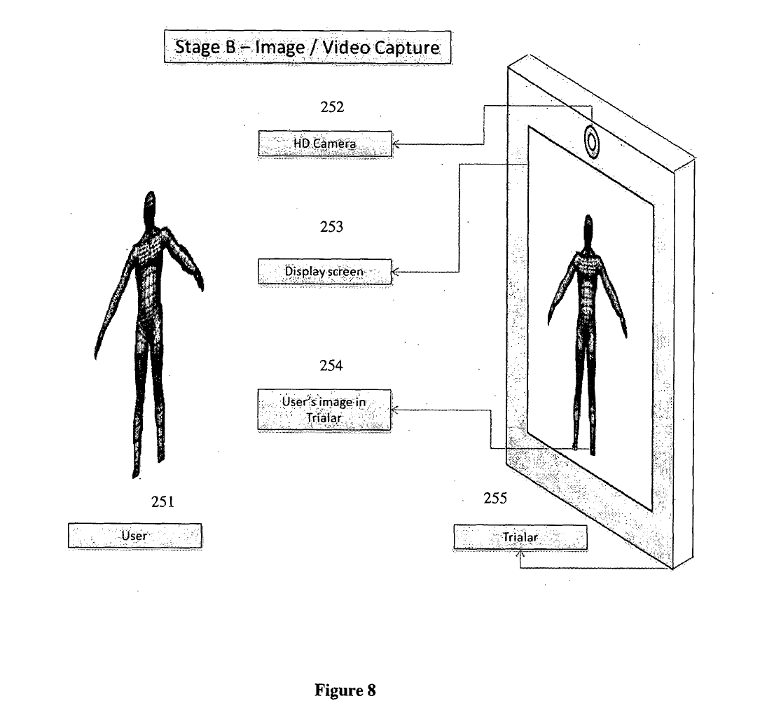

FIG. 8 illustrates image/video capture process wherein the digital camera (part 1) 201 and a Computer (part 2) 202 that constitute a part of the embodiments of the apparatus of the invention are put to use in this stage. The digital camera 252 is connected to the computer 202 either wirelessly or through a wired connection. It is placed appropriately, in a position and orientation relative to the Display (part 3) 203, so as to be able to capture the user of the invention in its field of view (FOV). In a preferred embodiment of the invention, the camera 252 is positioned at the center of the display 253 and oriented towards the user.

It is preferred that the lighting on the user is adequate for the camera 252 to capture the imagery 254 with high clarity. It is also preferred that the camera 252 has a technical specification of a LUX rating less than 1 and a resolution of at least SXGA (1280×1024 pixels)

In the operating mode of the invention, the digital camera 252 captures images of the user 251 present in its FOV at a continuous frame rate of preferably, 30 frames per second. The images, also referred to as frames are transferred to the computer 202 through wired/wireless connection which is sent to the following stage of the process of invention.

Stage C: Image Processing

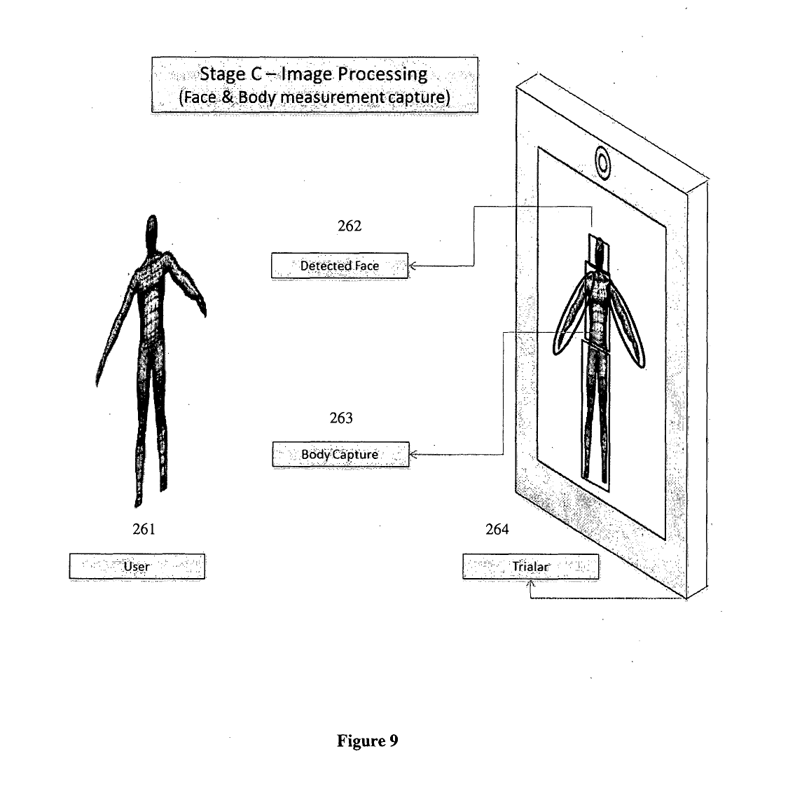

FIG. 9 illustrates image processing wherein the computer (part 2) 202 which is the most significant embodiment of the apparatus of the invention put to use in this stage, although image processing can be partially implemented in stage Busing some digital cameras. The images transferred through stage A described above constitute the input data for the image processing stage.

The object (of the user) information that is to be tracked in the input data is identified through a calibration mode. Typically, the object being tracked is the face 262 of the user 261. The identification may be automatically performed or manually performed as follows. The input digital imagery data obtained from stage A i.e. Digital Apparel Data Collection process which is further being processed by the computer 202 is displayed to the user on a display screen (part 3) 203. The user 261 or any other person, by utilizing an electronic input device, such as a wireless mouse may manually identify the object information. In an automatic calibration mode, the user's face and body measurements, with a desired degree of accuracy, are captured 263 using standard computer vision algorithms like edge detection, Gaussian filter, and morphological operations. In advanced calibration procedures, information regarding the user's more accurate physical measurements and analytical information regarding the user's apparel fit and any other appropriate optional information may be obtained. Through a set of standard image processing procedures, the object information is tracked in each frame of the input data by the computer 202.

Stage D: Augmentation and Display

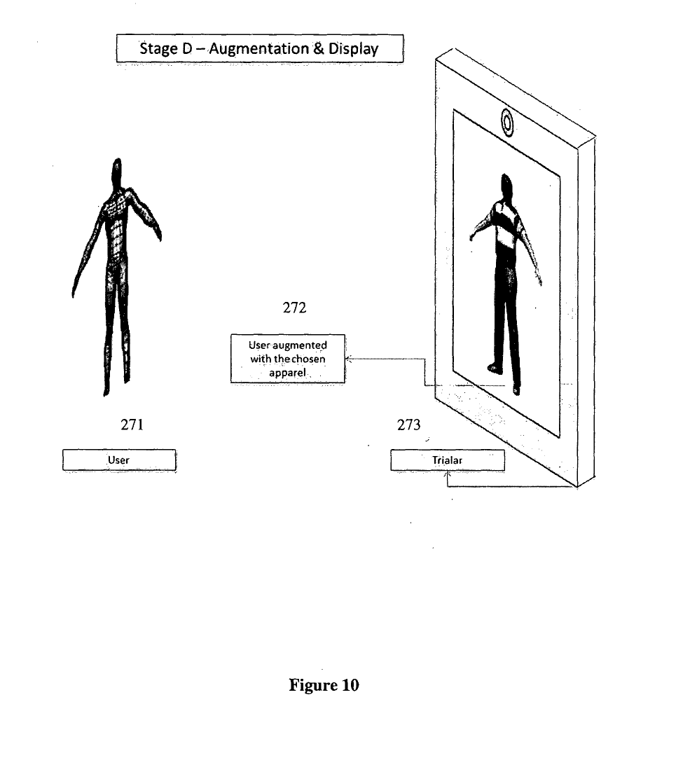

FIG. 10 illustrates augmentation and display process wherein the digital imagery processed in stage C, is displayed on the display screen 203, to the user 271. Digital image of a garment is selected from the digital database 243 obtained in stage A. The selection of a garment's digital image may be indicated by the user 271 by means of an input either through hand gestures or through the electronic input device described in stage C.

The selected garment's digital image is augmented on the input image data processed in stage C 272, by the computer 202. Position relative to the input image data chosen for the augmentation is computed on the basis of the object information that is tracked in stage C. The technique used is pixel by pixel manipulation using both object and apparel coordinate systems. The resultant augmented digital image is displayed 272 on the display screen 203. The result is indicative of the user wearing a virtual garment.

Stage E: Input Data Collection and Image Storage

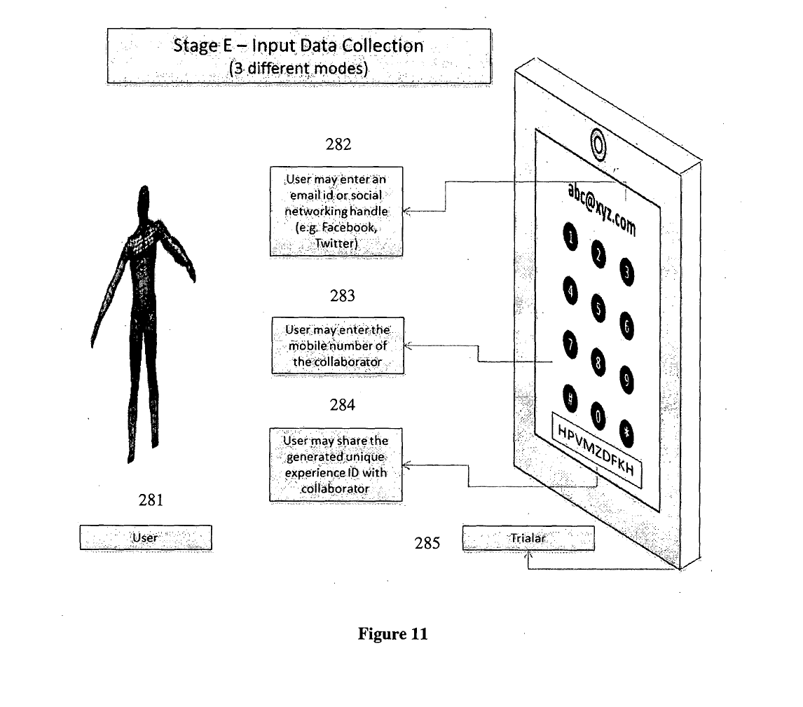

FIG. 11 illustrates input data collection and image storage process wherein an augmented digital image (or a collection) as obtained in stage D 272 that is further selected by the user 281 by means of the electronic input device, or through hand gestures is saved as an image or a video file and preferably uploaded to a server computer (part 5) 205 through the internet adapter (part 4) 204. The location where the digital imagery 208 is saved is typically stored and indicated in the form of a web hyperlink.

By means of the electronic input device, or through hand gestures, user's chosen cell phone number 283 or other appropriate identification such as an email address 282, in the form of input data is collected from the user.

Stage F: Message Transfer

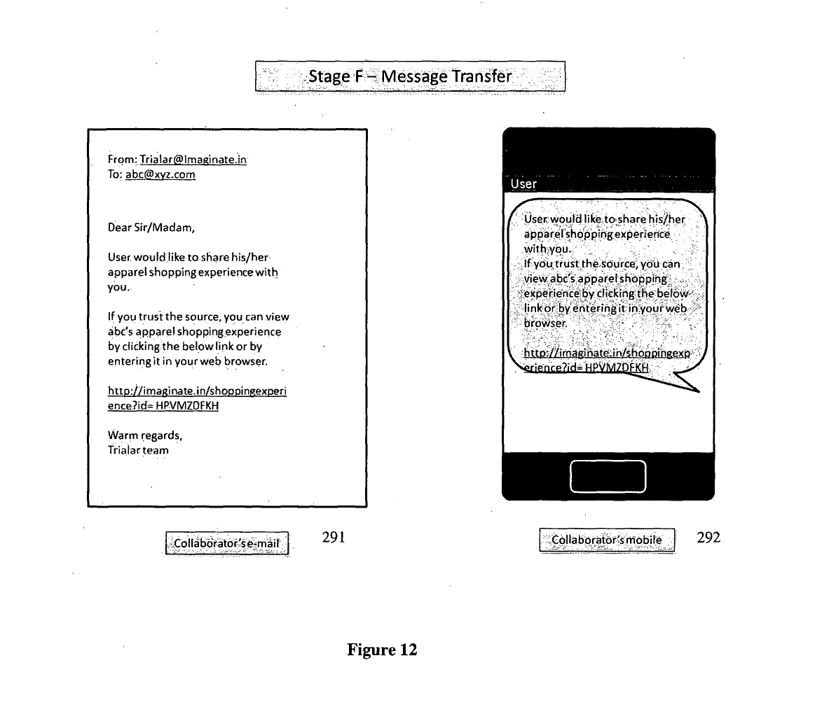

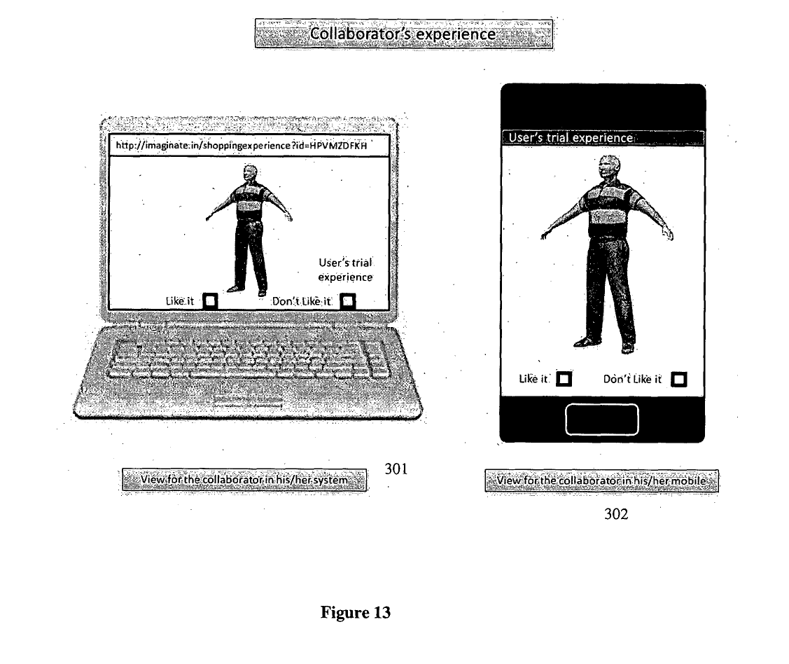

FIG. 12 illustrates the Message transfer process wherein the location of the saved chosen digital imagery, described in stage E, constituting part of the contents of a text message 283 or an email message 282. In a preferred embodiment of the invention, the message 283, 282 is automatically sent using a short message service (SMS) provided by the cellular network (part 6) 206, to the user's cell phone (part 7) 207 or other appropriate device. It is to be noted that the cellular network's 206 short message service may be accessed by the computer (part 2) 202 and internet adapter (part 3) 204 over the internet through a variety of third party SMS gateway providers in the preferred embodiment of the invention. This process is depicted in FIGS. 12 and 13.

The message obtained on the user's cell phone 207, may be shared by the user with a number of people interested. The interested people will be able to see the digital imagery of the user wearing virtual digital apparel 272 stored at a location indicated in the message, using a device such as a computer cum display unit 301, 302 which can be connected to the internet 291, 292.

Optionally, instead of sending a text message to the cell phone number 207, the uploaded imagery location text may be displayed on the display screen 203 to the user, that which can be shared by the user with interested people. This finds significant utility typically when the location is on a social networking platform 282 that can be shared by the user 281 with the user's friends and family or the entire public 284.

The utility provided to the user is instantaneous feedback about the fit, looks and such other quality of the digital garment augmented on the user's body in the uploaded imagery, from a number of interested people. The interested people are typically user's family and friends 284, who may be viewing them uploaded imagery in real-time as the user is trying out various virtual digital apparel using the current invention. The interested people may also be able to control the user interface of the user and advise on which apparel the user may try out. This enables a collaborative shopping experience through real and virtual presences.

The instantaneous feedback helps the user in quickly, efficiently and confidently selecting a particular set of apparel. The user may later optionally try out the selected set of apparel and finally buy the apparel. With the growing population density and traffic, the embodiments of the invention serves as a medium enabling an apparel customer to have the virtual presence of his/her family and friends in the apparel shopping experience.

1. A method for collaborative shopping in a virtual trial room, the method comprising:
a) collecting data pertaining to one or more digital apparel, comprising accessories;
b) capturing at least one of images or videos corresponding to the users or the one or more digital apparels, wherein capturing the at least one of images or videos corresponding to the users or the one or more digital apparels comprises
(i) capturing apparel imagery using a digital camera,
(ii) processing one or more digital apparel imagery captured, and
(iii) storing the one or more digital apparel imagery in a database
c) processing the at least one of images or videos;
(d) augmenting the one or more digital apparels with the at least one of images or videos associated with a user to obtain augmented digital apparels, and displaying the augmented digital apparels, wherein augmenting and display the augmented digital apparel comprises
(i) augmenting one or more selected digital apparel or accessory with a user's body profile or facial features to obtain an augmented image,
(e) processing an input from the users, wherein the input is processed based on one or more input modes comprising an external connected device, hand gestures or a touch interface; and
(f) transmitting augmented images or videos from the virtual trial room, to one or more collaborators devices to receive real-time feedback.

2. The method of claim 1, wherein the step of collecting data pertaining to one or more digital apparel, comprising accessories further comprises the steps of:
i. draping a mannequin with a physical apparel;
ii. capturing a picture of the mannequin using the digital camera;
iii. checking a relative orientation “theta” 104 against previous values of theta, said theta being obtained for each unique combination of the mannequin and physical apparel, as the relative orientation of the mannequin with respect to the digital camera wherein:
a) when theta does not exist, the step “(ii)” is repeated;
b) theta exists, the picture is transmitted to a computing device;
c) identifying and isolating the picture information, except that of the physical apparel; and
d) Adding the apparel heuristics such as type, size and price to the and stored in a database 112; and
iv. when there is a change in the relative orientation (theta) of the mannequin with respect to the digital camera by a fixed angle, the step “(ii)” is repeated.

3. The method of claim 1, wherein the step of processing images or videos further comprises:
i. positioning the user in the field of view of the camera; and
ii. capturing the user's images or videos by using the camera.

4. The method of claim 1, wherein the step of processing images or videos further comprises:
i. enhancing the images or video feed obtained in the step of image or video capture; and
ii. recording the user's body measurements by automatic detection or by manual input by the user.

5. The method of claim 3, wherein the user's features comprises at least one of (a) body dimensions and (b) facial features.

6. The method of claim 1, wherein the step of augmenting and displaying the augmented image or video further comprises:
i. enabling a user to process an input comprising an indicated to select or deselect a collaborative shopping mode;
ii. delineating the user's body profile, pixel by pixel, from the user's live image obtained from the camera and replacing the user's body profile with the selected digital apparel;
iii. rendering the transformed image on a display screen;
iv. performing a check to determine whether the body features have been detected from the user's live image, wherein performing the check comprises:
a) processing an input from the user, wherein the input comprises an indication to select an initial calibration mode for detecting the user's live image when the user's live image are not detected; and
b) processing an input comprising an indication to select a different digital apparel when the body features are detected,
wherein the user leaves the field of view of the camera when the different digital apparel, and
wherein an input that indicates a choice, from the user is processed from at least one of an external connected device, gestures, or touch interface directly on the display screen when the user selects the different digital apparel, wherein processing the input further comprises;
performing a check to determine whether the input from the user is using the gestures to indicate a change of digital apparel,
wherein the input is compared with a preconfigured actions for the change in the digital apparel when the gestures are not used as the input, and
wherein user's hand position is compared with the user's live image, and wherein a position that indicates preconfigured action of the change of the digital apparel is determined when the user's hand position matches the user's live image,
i. wherein when the input does not indicate a change of the digital apparel, the user's body profile is delineated, and
ii. wherein when the input indicates a change of the digital apparel, a variable of the digital apparel is changed to a next available digital apparel obtained from a digital apparel database.

7. The method of claim 1, wherein collecting data pertaining to one or more digital apparel comprising accessories comprises:
i. processing an input with identification data when the user chooses to shop collaboratively;
ii. processing details pertaining to the one or more collaborators from the user; and
iii. repeating the step of augmenting and displaying the augmented digital apparel when the user does not shop collaboratively.

8. The method of claim 1, wherein the step of transmitting one or more messages comprises:
i. enabling the user a choice to input data and enable collaborative mode based on at least one of a mobile number, an email address, a social networking ID, which is authenticated 147 (SP) or a twitter ID,
a) wherein when the mobile number is chosen
i) a value of the social networking ID is set to the mobile number, wherein the value of the social networking ID is set to the email address when the email address is chosen,
ii) the augmented image of the user with the digital apparel is uploaded to a unique web service location in a server, and
iii) a message is communicated to the user's ID using a short message web service,
b) wherein when the user selects the social networking ID, which is authenticated,
(i) the augmented image of the user with the digital apparel is uploaded to a unique web service location in the server, and
(ii) the unique web service location is embedded in the social networking ID, which is authenticated directly or through the current service plugin being subscribed to by the user.
c) wherein when the user has chosen a twitter ID:
i) the augmented image of the user with the digital apparel is uploaded to the unique web service location in the server, following which a tweet or relevant message of the unique web service location into the twitter ID is posted directly including a hashtag, and
ii. uploading the augmented image of the user with the digital apparel to the unique web service location in the server when any of the mobile number, the email address, the social networking ID, which is authenticated or the twitter ID are not selected; and
iii. processing an input from at least one collaborator comprising an indication to navigate to view the digital apparel in the UI, wherein the UI comprises an option to indicate change of apparel through a web service,
wherein a) when the collaborator indicates a change of apparel 162, the selected option is transferred from the unique web service location to software in the step of augmenting and displaying the augmented image or video; and b) transmitting the one or more messages is terminated when the collaborator does not indicate a change in the apparel.

9. A system for collaborative shopping in a virtual trial room, the system comprising:
an operating system having a user interface;
a core engine having a feature detector;
a camera that captures apparel images; a memory that stores an apparel and accessory database, wherein the database comprises apparel images captured using the camera, wherein the memory further stores means to:
(a) collect data pertaining to one or more digital apparels, including accessories,
(b) capture one or more images or videos pertaining to the users or the apparel,
(c) process images or videos captured,
(d) augment digital apparel with user images or videos and display the augmented digital apparel,
(e) collect an input data from users, and
(f) transmit one or more messages including augmented images or videos from the virtual trial room, to one or more collaborators devices to receive real-time feedback.

10. (canceled)

11. (canceled)

12. The system of claim 9, wherein the camera is positioned at the center of the display and oriented towards the user.

13. The system of claim 9, wherein the camera comprises technical specification of a LUX rating less than 2, and wherein a resolution comprising (640×480 pixels).

14. The system of claim 9, wherein the means to process images or videos collects information comprising an object to be tracked in the input data that is identified based on a calibration mode, wherein the object being tracked comprises face or body of the user, wherein calibration mode comprises any of an automatic calibration mode and an advanced calibration mode, wherein the user's face and body measurements, with a desired degree of accuracy, are captured using at least one of an edge detection technique, a Gaussian filter technique, and a morphological operation in the automatic calibration mode, and wherein information specific to the user's physical measurements and analytical information specific to user's apparel fit and are obtained in the advanced calibration mode.

15. The system of claim 9, wherein the means to process images or videos displays the data collected by the digital apparel data collection module to the user on a display screen to identify the object information, and wherein the object information is tracked in each frame of the input data.

16. The system of claim 15, wherein the means to augment and display further configured to:
i. select a digital image or video of a garment from the database, wherein digital image or video of the garment is selected based on an input comprising at least one of hand gestures or an electronic input device connected to the system;
ii. augment on the input image or video data processed where a position relative to the input image or video data chosen for the augmentation is computed based on the object information; and
iii. perform pixel by pixel manipulation using at least one of an object coordinate technique and an apparel coordinate technique, wherein a resultant augmented digital image or video is displayed on the display screen, wherein the resultant augmented digital image or video is indicative of the user wearing a virtual garment.

17. The system of claim 9, wherein the means for input data collection is further configured to: upload one or more augmented digital images or videos to a server, wherein the location the augmented digital images or videos are stored is indicated in the form of a web hyperlink.

18. The system of claim 9, wherein the means for message transfer further:
i. processes an input comprising at least one of a mobile phone number, an email address, a social networking identifier, or an unique ID of one or more entities the user seek to collaborate;
ii. initiates the collaboration by sending a web link to an intended entity, based on the input, wherein the intended entity is a collaborating entity;
iii. enables the collaborating entity to view the shopping experience of the user; and
iv. enables the user and the collaborating entity to exchange notes via a central repository.

19. The system of claim 18, wherein:
i. a social networking site of an entity is populated with a link to the user's shopping experience when the user provides a social networking identifier of the entity for collaboration, and
ii. the collaborating entity is granted access to the image or video pertaining to the user with the digital apparel or accessory when the user provides the unique ID.

20. (canceled)

21. (canceled)

22. (canceled)

23. (canceled)

24. (canceled)

25. (canceled)

26. (canceled)

27. (canceled)
